(19) United States
(12) Patent Application Publication
(10) Pub. No.: US 2008/0041947 A1
(43) Pub. Date: Feb. 21, 2008

(54) System for identifying contents of closed containers using RFID tags

(76) Inventors: Allen Hollister, La Habra, CA (US); Gary Barta, Duarte, CA (US); John T. Armstrong, Pasadena, CA (US)

Correspondence Address: Phil Virga, 1525 Aviation Blvd., #105, Redondo Beach, CA, 90278, US

(21) Appl. No.: 11/502,752

(22) Filed: Aug. 14, 2006

(51) Int. Cl. G06Q 30/00; G08B 13/14; G08B 1/08

(52) U.S. Cl. 235/385; 340/572.1; 340/539.13

(57) ABSTRACT

A system and method is provided which allows for instant recognition of contents of a closed container by providing descriptive information in the form of a picture, and/or an audio description, and/or text of the contents of the closed container taken at the time of packing the container. The system keeps track of the contents of an individual container by storing information describing the contents of the container that is then related to a unique identification number stored in a radio frequency identification tag affixed to the container. This information is then stored in a digital database for later reference.

### FIELD OF THE INVENTION

The invention relates generally to a system for fast accurate recording of contents in a closed container. More particularly, the system instantly identifies the contents of a closed container using RFID tags and an associated database containing pictures, audio, and text.

### BACKGROUND

A major problem of both the commercial world and the personal world is determining the contents or locating a specific item that has long ago been packed away in a closed container of some kind (such as a cardboard box). In many cases the reason the information does not exist is because it is so tedious and time consuming to record the information at the time of packing the container, that it simply isn't done, or it is done so poorly that the information that does exist is basically worthless. Many times the information is hand written (perhaps illegibly) making computer searching impossible. At the other end, even if the information exists in some form, it is usually not in a form that will allow someone to easily find the container in which the item is located.

Right now when a person must move, he hires a moving company to do the task. The movers come in and proceed to pack the entire household in boxes that are then closed. At best, someone will write on the box, the room from which the contents were obtained (and sometimes this doesn't work as some boxes may contain items for other rooms). Some moving companies will have a second individual write down on paper the contents of each box to establish an inventory, but this is seldom related to the individual boxes. In addition, the shipper may get only a carbon copy that is often unreadable. At the other end, the movers come in and unpack the truck as fast as possible. They move boxes into the rooms most closely associated with the original rooms (usually with a few mistakes). In the end, the shipper is left with a house full of boxes all stacked on top of one another wondering what goes where. He is forced to open each box to determine its contents. If he decides not to unpack all the boxes but instead store a number of them in the basement, then he has the task of figuring out at some point in the future what each box contains. This usually means opening all the boxes again. All of this is very tedious. The major reason the contents of each box are not recorded in detail for future use is because it is time consuming and expensive to do so. Even when a person is packing his own containers for shipment or storage, he seldom keeps an exact record of the contents of each box for these same reasons.

What is needed is a system that allows a user to easily find out the contents of an individual container in real time without opening the container and is cost effective in doing the initial information recording during packing of the container. Identifying the contents of a closed container using RFID tags and an associated database containing pictures, audio, and text solves this problem in a novel and unique way.

### SUMMARY

A system and method is provided which allows for instant recognition of contents of a closed container by providing descriptive information in the form of a picture, and/or an audio description, and/or text of the contents of the closed container taken at the time of packing the container. The system keeps track of the contents of an individual container by storing information describing the contents of the container that is then related to a unique identification number stored in a radio frequency identification tag affixed to the container. This information is then stored in a digital database for later reference.

Other features and advantages will be apparent to one skilled in the art given the benefit of the following disclosure.

### BRIEF DESCRIPTION OF THE DRAWINGS

FIG. 1 shows a block diagram of a system illustrating identifying contents of a container using RFID tags at the time of packing;

FIG. 2 shows a block diagram of the system shown in FIG. I used to find objects inside of containers in a large universe of such containers;

FIG. 3 pictorially illustrates how a user might take a photo of the contents of a container;

FIG. 4 pictorially illustrates the concept of packing boxes within boxes with the RFID tags placed internally for security purposes

FIG. 5 is a flowchart describing one method for identifying contents and placing them in a container using RFID tags at the time of packing; and

FIG. 6 is a flowchart describing one method used to find objects inside of containers in a large universe of such containers using RFID readers.

### DETAILED DESCRIPTION OF THE DRAWINGS

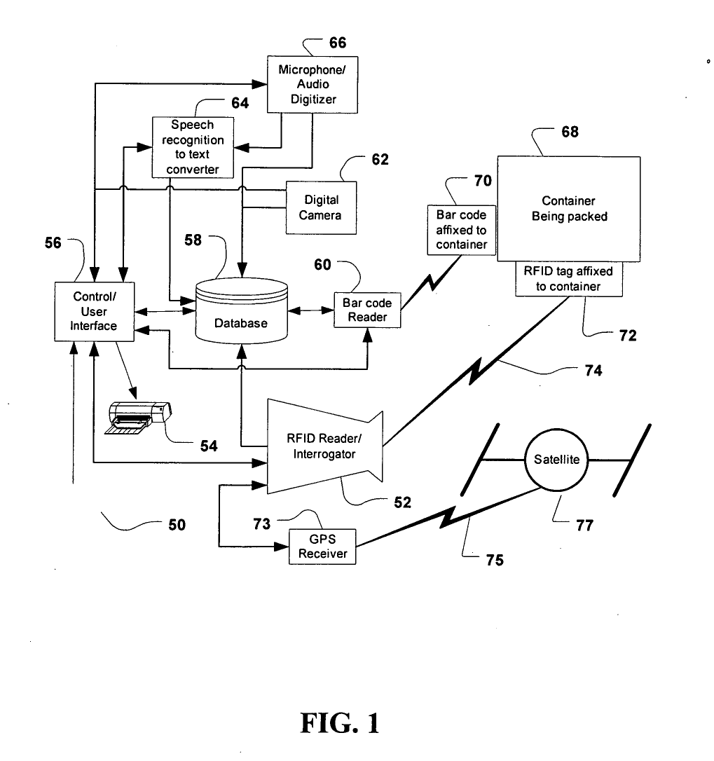

Referring now to FIG. 1 there is shown a block diagram of a system for identifying contents of a container 68 using RFID tags 72 at the time of packing with items of interest wherein an RFID tag 72 is affixed to each container 68. This tag 72 contains a unique ID number for the universe of all containers that will be stored in a database 58. The tag 72 may or may not contain write-able memory that may be used to store information about the container. Referring once again to FIG. 1, an RFID reader/interrogator 52 that is capable of reading and writing information to the tag 72 through a wireless link 74 is shown for those cases when it is desired to write information to the tag 72.

Additionally, a bar code reader 60 may be provided that is capable of reading a bar code imprinted on a bar code label 70 affixed to the container. While the preferred embodiment is to use the RFID reader/interrogator 52, there are a lot of legacy containers that have a bar code label already attached. In addition, bar codes are at present still cheaper than RFID tags, and for this application, the minimum requirement is to simply have a unique ID number associated with the container 68 that may be read in some way by the system and the bar code accomplishes this task. Of course, to use a bar code label 70 in place of an RFID tag 72 places more constraints on the usage of the reader 60 because all containers must be completely accessible and within a foot or so of the reader 60. This is not true for an RFID reader 52 that may be located many feet from the container 68 and may see through other containers eliminating the requirement for container accessibility. Cost versus versatility becomes a tradeoff wherein an RFID tag costs a little more but offers the most capability, while a bar code reader is cheaper but puts constraints on the system.

In many cases there is a need to convert legacy containers that currently use bar codes with the newer RFID tags. In these cases it may be necessary to use a barcode reader 60 as part of the system with an RFID reader/interrogator. Specifically the system would first scan the bar code 70 using the bar code reader 60 to obtain the ID number stored on the bar code 70. To avoid the need for a complete change in the database management of the universe of containers, the system would probably write at least the ID number obtained from the bar code 70 into the RFID tag 72. This would require the RFID tag 72 to have write-able memory. If the RFID tag 72 does not have write-able memory then the barcode 70 ID would be stored into the database 58 along with the RFID tag 72 ID.

Additionally, there may be text associated with the bar code 70 affixed to the container 68 stored in a database that describes the contents of the container 68 (different from the database 58 shown in the system of FIG. 1.) This text information describing the contents of the container 68 could be accessed when the bar code 70 is read. This text may then be written into the RFID tag 72 affixed to the container 68 if the RFID tag has sufficient memory to store the data, and/or the text may be written into the database 58 along with the associated RFID tag 72 ID that in the future will allow for identification of the contents of the container 68. It should be noted that at this point, the conversion from barcode to RFID did not require the opening of the container. However, in some cases, it may be desirable to do so. For example, the text describing the contents may be non-existent, or contain very little information. In which case, the desire is to obtain much more complete information as to the contents. There may be a desire to verify the contents that requires opening the container 68. If the container is opened, then the rest of the system shown in FIG. 1 comes into play with its ability to obtain pictures and audio that describes in great detail the contents of the container as will be more fully described below. This information would then be stored in the database 58 with the associated RFID tag ID 72 affixed to the container 68. Also, the container 68 may come manufactured with RFID tags 72 already made a part of the container during the manufacture of the container.

Turning once,again to FIG. 1, a digital camera 62 may be used to record the contents of the container 68 being packed. If necessary it is possible to take multiple pictures of the container 68 as it is being packed. All of these pictures will then be associated with the single RFID tag 72 affixed to the container 68. In this way, the contents of the container 68 may be more easily seen at the time the user is interested in finding the contents of a container 68. For example, a container may contain a number of books. As the first row of books is loaded, a picture is taken that shows the titles of each book. A second row of books is loaded on top of the first row and a second picture is taken that shows the titles of each of these sets of books. This is repeated until the container is filled. At this time a set of pictures will exist that in total shows the book titles for each book in the container.

Also a microphone/audio digitizer 66 may be used to capture sound. As the container 68 is being packed, a person describes each item as it is placed in the container 68. For example if the container 68 was being packed with books, the person might say: “Book: Vector Analysis”. After a container 68 is packed, a digital voice recording that describes the entire contents of the container 68 exists that may now be linked to the RFID tag 72 affixed to the box. The recording is then stored in a database 58 linked to the ID number so that at a later time, the user can scan the RFID tag 72 on the container 68, obtain the ID number from the tag and then go to the database 58 to obtain the voice file that describes the contents of the container 68.

The microphone/audio digitizer 66 may also be used to feed the speech recognition to a text converter 64. The speech recognition to text converter 64 takes the spoken word describing the contents of the container 68 and converts it to text so that it may be stored as a text file in the database 58. This text file is then associated with the RFID tag 72 affixed to the container 68 and thus provides a text database describing the contents of the container 68. This database may then be searched at a future time to determine the contents of the container 68 or to determine if any of the containers contain the searched for item. It is possible to obtain text information from other sources such as a keypad and typing the information, but this is much simpler.

The database 58 stores all of the information recorded by the camera 62, the microphone audio digitizer 66, the speech recognition to text converter 64, and the ID number of the RFID tag 72 affixed to the container 68. The RFID tag ID 72 is used as the key field in the database and all of the other information is associated with this number. The physical medium for the database 58 may be almost anything from flash memory to a small hard drive. In the future, as RFID tags become more advanced, the information may be stored on the tag itself.

Additionally a keyboard 50 may be used to enter text information containing the contents of the container 68. This would be cheap but labor intensive. It may also be used to enter special information concerning the packing of the containers and/or of high interest to the user. For example, suppose a household moving company is using the system. It is very desirable to know the room that the contents for the container 68 came from. This information is so valuable that it is frequently written on the side of the container by hand. Another piece of information of great value is the name of the person who packed the container and a final piece of information would be a time and date stamp as to when the container was packed and closed. This final piece of information may be read automatically by using the system clock (not shown) in the system. The persons name would only have to be entered once, and the room he was working in would only have to be entered once given that most moving companies require the name of the room and the packer's initials be written on each container manually, it is likely that a considerable savings in time would result. There are other ways to enter this information automatically. For example, each packer could have his own RFID tag that identifies him. This may be read by the RFID reader/interrogator 52 during a special read cycle. A room may have a RFID tag associated with it that may also be read by the RFID reader/interrogator 52. To assist the packer and shipper, a GPS receiver 73 which is capable of receiving information from GPS satellites 77 by RF link 75 can automatically provide position of the location of the place being moved and this information added to database 58 and associated with container 68.

Referring once again to FIG. 1 all of the system is under the control of a Control/User Interface 56. The Control/User Interface 56 waits for the user to take a picture, or speak into the microphone. When these events happen, it stores temporally the resulting picture and/or the speech/and/or the text generated from the speech. It stores as many of these files as the user chooses to create. When the user finally has the container filled, he tells the system to read the RFID tag 72 affixed to the now packed container 68. The Control/User Interface 56 then instructs the RFID Reader/Interrogator 52 to read the ID from the tag 72. The Control/User Interface 56 takes this information from the RFID Reader/interrogator 52 and combines it with the previously captured picture/audio/text files as part of the identifying information for these files and stores all data into the database 58.

A printer 54 may also be provided wherein after the container 68 is packed and the RFID tag ID 72 has been read and associated with the pictures/audio/text describing the contents of the container.68 some of the items might be printed out on a contact paper that may be easily affixed to the container 68 for easier verification at a later time. For example, one or more of the photos may be printed and if text information exists, that may also be printed. Another example is the moving company may use the keyboard 50 for printing the room in which the container was packed, and by whom and print the time and date stamp as well. The system would work using the following sequence. When the packer (not shown) sends to the system a signal that the container was packed and closed, the system would read the RFID tag ID 72 affixed to the container 68 (and/or the bar code 70 affixed to the container 68). It then links all of the data taken that describes the contents of the containers (and the special information that the user desires such as the room in which it was packed and the packers name along with a time stamp). The system then writes this to the database 58 and also begins to print the desired information on a label that the packer then affixes to the side of the container 68. This label is likely to be much more legible than the average packer's handwriting.

The system comprising the camera 62, database 58, control/user interface 56, RFID reader/interrogator 52, microphone/audio digitizer 66, speech recognition to text converter 64, bar code reader 60, GPS receiver 73, and any other component may all be combined into one package or be totally distributed. For example, the control/user interface 56 might be a notebook computer and the camera 62 may be a separate digital camera and so forth. By way of example the camera 62 may be a small box that straps to the wrist of the person loading the containers. If the link from the camera 62 to the rest of the system were wireless, then this would create the ultimate in convenience for the person doing the packing. When the person wanted to take a picture of the contents, he literally would have to do nothing more than point his wrist at the box and push a button. The picture would then go over a wireless link 74 to the main system where it would be appropriately cataloged and placed with the other pictures related to this container. Similarly a wireless microphone/audio/digitizer 66 may be placed on the person packing the container such that it automatically records his voice as he packs. When he is finished packing the container, he might push another button that causes the system to read the RFID tag 72 and store the all of the information into the database 58.

It should be noted that the system does not require picture information, audio information, and text information to be stored in the database 58 wherein only one of these pieces of information is required to identify the contents of the container 68. By way of example the system may use only a camera 62 and records only pictures to identify the contents of the container 68. Accordingly the data structure for the database 58 may be configured for the type of information stored. As an example, assume that a system contains only a camera 62 then the pictures to be stored in the database taken by the camera associated with the RFID tags 72 ID may be MPEG or JPEG or any other storage algorithm. Also, techniques for cataloging the information may vary. By way of example if the tag ID for this RFID tag 72 is 500 this allows for multiple pictures to be taken for each container. As each picture is taken, the picture number is concatenated with the tag ID (500) separated by some character (for example a period) and is used as the label for each picture. Therefore the first picture taken for this container 68 would be 500.1, the second picture would be 500.2, third would be 500.3 and so forth. Each picture is labeled accordingly and stored in the database 58. Later, when the user is trying to find out the contents of the container, all the system has to do is read the RFID tag 72 on the container 68 to obtain the tag ID. This ID is used to search the database using the numbers prior to the decimal point as the key. Then any set of pictures that match this number must be a picture of the contents of that container 68.

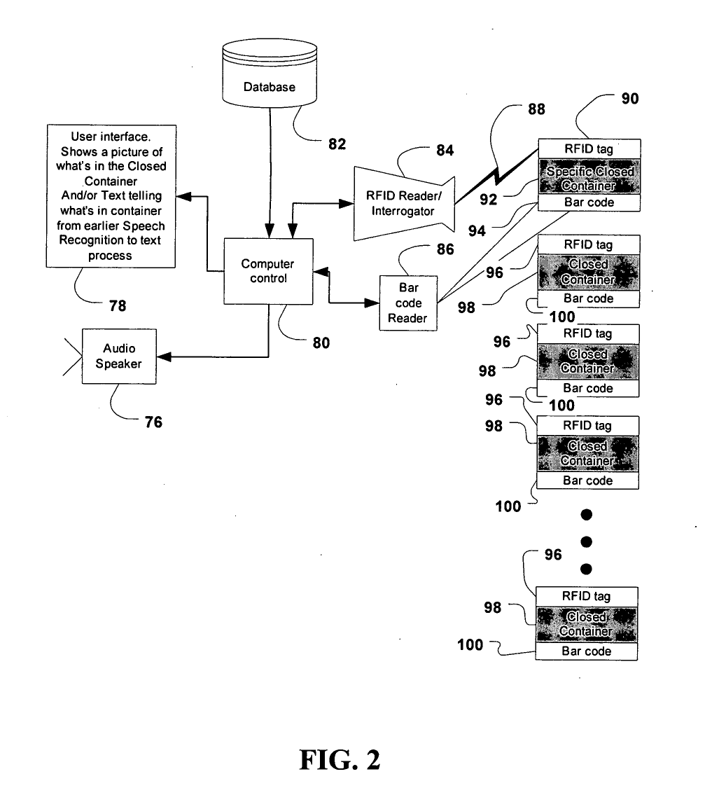

FIG. 2 shows a block diagram of the system shown in FIG. 1 used to find objects inside of containers in a large universe of such containers 98. Affixed to these numerous containers are an RFID tag 96 and an optional bar code 100. The user does not know the contents of the containers and wishes to find some specific item in one of the containers 92 without opening all the containers. He uses the system to query the RFID tag 90 for its ID number that is affixed to the specific container 92 that the user thinks might contain the item of interest. The RFID reader/interrogator 84 then reads the RFID tags 90 ID number using a wireless link 88. Once this number is known, the system goes to the database 82 that contains information on all the containers and looks for a container's 92 specific information. Once the system finds this information, it is displayed to the user using a user interface display 78 and/or an audio speaker 76. Text and pictures may then be displayed using the user interface display 78 and the stored speech describing the contents may be spoken over the audio speaker 76. If multiple pictures are stored, the system will allow the user to view each picture in turn either automatically as a slide show, or at the push of a button. Optionally, in place of the RFID reader/interrogator 84 and the RFID tag affixed to the container 92, a bar code reader 86 could be used to read the ID number stored in the bar code 94 affixed to the side of the container 92.

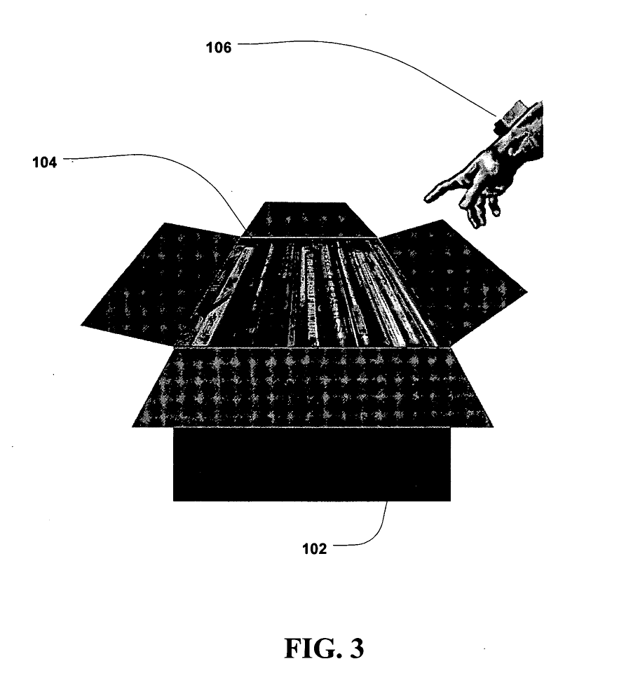

FIG. 3 pictorially illustrates how a user might take a photo of the contents 104 of the container 102. Referring to FIG. 3 when the user is ready to take a picture of the contents of the container 102, he makes use of a miniature digital camera 106 strapped to his wrist wherein by simply pointing his arm at the contents of the container 104, snaps the picture and then gets on with additional packing or closing up the container 102 or whatever he needs to do next. The system automatically takes care of getting the picture, associating it with the ID from the RFID tag affixed to the container and putting the result into the database. The system described above saves time over the technique used today where the packer must write by hand, at a minimum his name and the room the contents of the container came from. In some cases the packer must actually write by hand every item packed into the container.

There are two distinctly different users for this system. There is the original packer of the containers who is not only responsible for packing the containers, but also must keep track of the contents of the container. This is the packing side of the container. The other user is the person who is confronted with a large number of closed containers and needs to be able to find a particular item contained in one of the containers; preferably without opening all of the containers. A slightly different need at this end is a need to just determine if an item is in one of the containers, or to take an inventory of all the containers to make sure nothing was lost from the time it was packed until the present time.

In use the camera 62 is strapped to the wrist of the packer for ease of use and a microphone audio digitizer 66 exists somewhere close enough to the packer that the packer's words may be heard and recorded. When the packer first arrives on the site he begins by entering his name and any other global information important to the particular task that needs to be recorded along with the specific information regarding the contents of the containers. He then acquires a container 68 making sure that it has an RFID tag 72 affixed and /or a bar code 70. He begins packing the container 68 with the desired contents. Once again by way of example if the contents are books he packs the books into the container while reading the title of each book aloud. The system simultaneously records this sound and converts it to a digital equivalent. It is unimportant exactly what digital code is used to represent the sound as long as it is consistent throughout the system. The system automatically does two things when it records this speech. 1) It stores the digital equivalent of the voice into the database 58 for later playback, and 2) it sends the voice into a speech recognition engine 64 that converts the speech to text that is also stored in the database 58.

As the packer fills a row of books where the addition of additional books would obscure the previous books packed, he takes a picture of the contents. He does this by simply pointing his arm that has the miniature digital camera 62 strapped to his wrist at the container and pushing a button to obtain the picture. He need do nothing more as the system now takes the picture and places it into the database 58. The packer continues to pack the container with items, speaking the name of each item as he goes, and occasionally stopping for a brief second to take a picture and does this until the container is filled. Once the container is full, the packer pushes another button that causes the system to associate all of the acquired pictures, audio files, and text files that describe the contents with the ID number that has been read from the RFID tag 72, or if the bar code reader 60 is used instead of the RFID reader/interrogator 52, the ID number stored on the bar code affixed to the container 70. Next, the system begins to print the label using the printer 54 that may be physically located on or next to the container 68. The information to be printed will vary from one use to another wherein the desired information to be printed might be programmed in at the beginning of the day, or it might be programmed in by the shipper at the request of the customer. The point is some people may want to print only pictures, others may want the ID number, who did the packing, and a time stamp. Still other users may want everything printed while others might not want any label at all. The flexibility exists to provide all of these things. While the printer is printing the external label, the packer is busy closing up the container. After he finishes closing the container, he removes the label from the printer, and affixes it to the container. After that, he moves on to the next container. In summary, the packer only needs to speak the name of the item he is packing as he packs the container, at critical times he aims his arm at the container and takes a picture, after the container is full, he pushes a button to let the system know it is full. He closes the container and then affixes the label printed by the system to the container. He wastes very little time in doing all of this but the result is a complete inventory stored as pictures, text and audio in the database that may be used to track the items very closely.

Another advantage of the system is if something gets damaged in route the moving company or customer may go back to the original database and look at the pictures to determine if the container had been properly packed or if the damage was due to something else. At the end of the packing, a complete inventory of every box will be contained in the database. The truck containing all the boxes may also be scanned using RFID tags (but no bar codes) and the contents of the truck compared against the database containing the complete inventory. In this manner, one could see if any containers had gone missing (or if any of the boxes had been opened and some of the contents had gone missing.) At the other end of the trip, the same scan could be done to prove that nothing was “lost” during the trip. This would provide great reassurance for the customer of the moving company to know that the items were under close control.

Another application is the case where a legacy system of containers already packed but identified with bar codes is being converted to RFID tags. The system performs this task by having the user first scan the bar code 70 on the container 68 with the bar code reader 60. Varying amounts of information about the contents of the containers might be available in various forms of storage (from paper to computer database). If the data is already in a computer database and is deemed reliable, it is probably sufficient to take this information directly from this database after the bar code has been read. If the amount of information is small, it could be written directly to the newly attached RFID tag 72. If it is larger, or if desired, it may also be written into the systems database 58. Under this circumstance, the container need never be opened. In many instances, the stored contents data will no longer meet the needs of the organization, or there may not be trust in the data and a desire exists to do a complete inventory where the containers are each opened and the contents examined. Under this circumstance, the system would operate much like before where a packer would examine each item, speak the name of the item into the microphone, take pictures as needed and otherwise do exactly the same as described above.

When the user is confronted with a very large number of closed containers and is attempting to find an item within one of those containers without opening any of the containers all he has to do is pick up the RFID reader/interrogator 84 (or a bar code scanner 86 if a bar code was used in place of the RFID tag), aim it at a container and push a button. The system will immediately read the ID stored in the RFID tag 90 affixed to the container in question 92. The system uses this information to go to the database 82 to obtain all of the information stored that is related to that particular container. If pictures were stored, the system would display them on a graphics display of the user interface 78 and may allow the user to automatically step through them in a slide show like fashion, or it could allow the user to push a button to advance to the next picture thus giving the user more time to study each picture. If text information is available, it could display this on the same monitor either as its own screen or beside each in a screen beside the picture. All the while these results are being displayed; the recorded audio that describes the content would be heard over the Audio Speaker 76.

Finally, the user might want to peruse the database on a computer prior to going on a search. If the item is found in the database and it is associated with an individual container, the user has a very good chance of finding the object. But if the user cannot find the item in the database, there is a good chance it isn't there at all. In any case, because the item is not in the database, the system won't help him as it relies on the database for information. If text information is stored in the database, the database is easily searched using standard computer search tools. If no text is stored, but voice is available, either the user listens to all of the speech stored in the system which would be tedious, or he may route the speech into his own speech to text recognition program and then use the output of this program to do the search for the actual item using standard text computer search tools. If pictures are stored in the database any number of photo display programs may be used to walk through all the pictures in the database. Once an item is found, then additional information like what room it was packed in, who packed it, what the ID number of the RFID tag is on the container holding the item becomes immediately available and useful for finding the object.

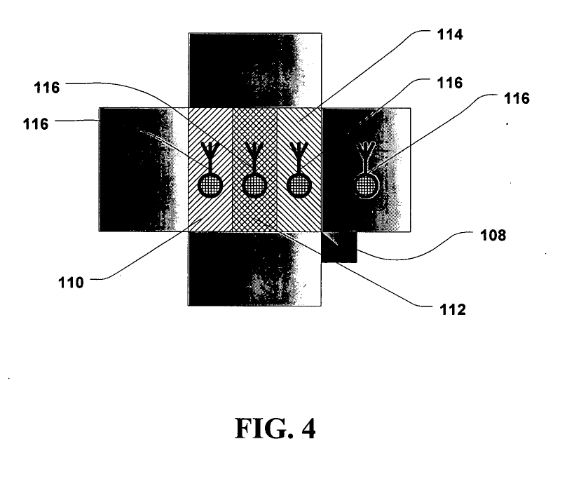

FIG. 4 shows the concept of packing boxes within boxes with the RFID tags placed internally for security purposes. The larger container box 108 has an RFID tag 116 affixed to inside of one of its cover flaps. The smaller containers 110, 112, 114 each have an RFID tag 116 affixed to each container. The RFID tags 116 all have their data encrypted so that only those people who have the decryption key and access the appropriate RFID reader can determine the contents of the internal boxes. Because the large container box 108 has its RFID tag 116 fixed internally, there are no identifying marks on the outside of the container that would tell an observer the contents of the container.

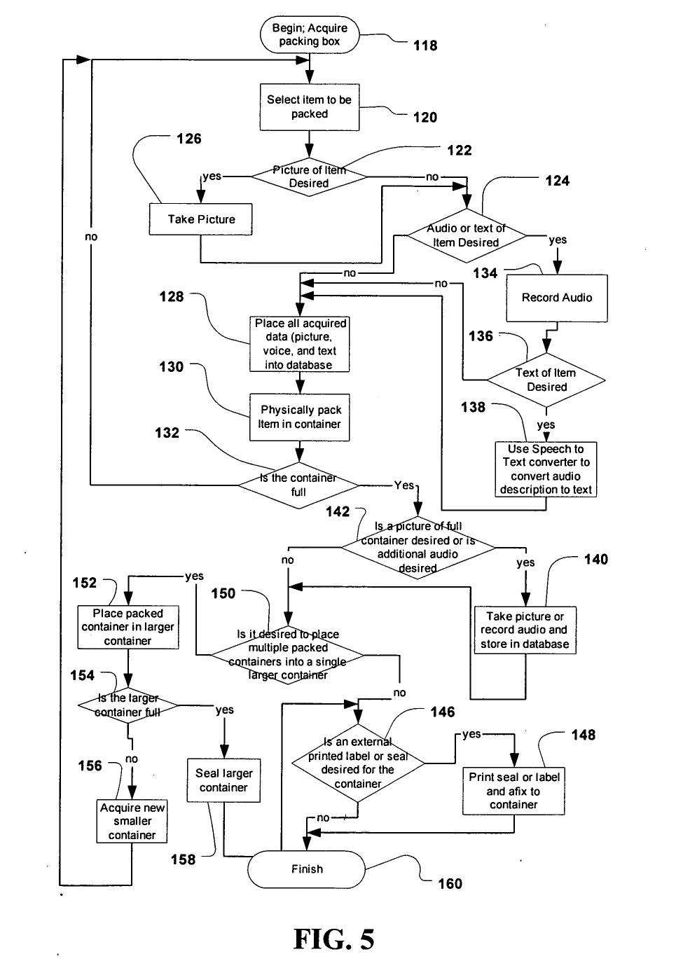

Turning now to FIG. 5 there is shown a flowchart describing one method for identifying contents and placing them in a container using RFID tags at the time of packing. The user first acquires a packing box or container 118 and selects an item to be packed 120. Next the user determines the type of descriptive information for identifying the item to be packed wherein if a picture of the item is desired 122, then a picture is taken 126. If an audio description of the item is desired 124 then an audio description is recorded 134. Similarly if a text description of the item is desired 136 then a text description is entered 138 by using a speech to text converter to convert the audio description to text. Once the user has acquired the desired descriptive information, whether a picture, audio, text or a combination thereof, then all of acquired data is placed 128 in an associated RFID database for later use as will be more fully described below. The item is now placed physically in the container 130. If more items are to be placed within the container then the process is repeated 120 until there are no more items or the container is full.

Referring once again to FIG. 5, once the packing box or container is full, the user decides 142 whether to take a picture or record additional audio of the full container box describing the container contents in general terms as an example, dishes or books and records the overall picture of the contents and/or audio description into the RFID database 140. The user may also desire to place the multiple packed boxes or containers in to a single larger container 150 and after placing the packed container into a larger container 152 determines if the container is full 154. If the larger container is not full then the user repacks the containers into a smaller container 156 and goes on to the next item to be packed. If the larger container is full then it is sealed for transport 158. Lastly, the user may then print an external label or seal for the container 146, print the seal or label and affix it to the container 148. The container with or without external label is now ready for shipment to its next destination 160.

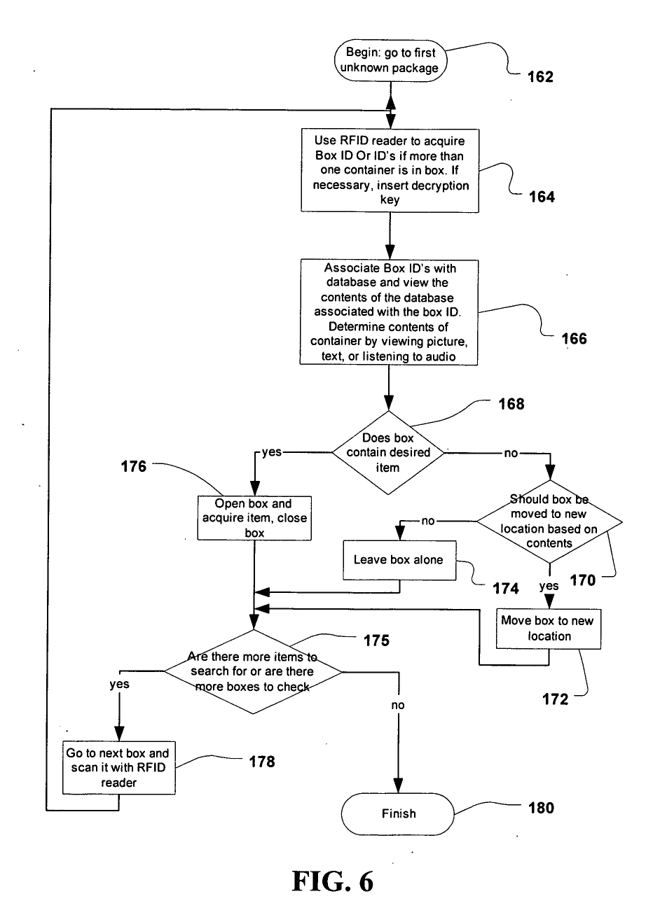

Referring now to FIG. 6 there is shown a flowchart describing one method used to find objects inside of containers in a large universe of such containers using RFID readers. The user first goes to an unknown package 162 and using an RFID reader acquires the boxes ID or ID's if more than one container is in the box 164. If necessary a decryption key may be used to access the RFID database. The user now associates the box ID's with the database and views the contents of the database associated with the box ID and determines the contents of the container by viewing the descriptive information, i.e., picture, text or by listening to the audio description 166. The user now may determine if the box contains a desired item 168 and opens and acquires the item and closes the box 176. Alternatively, the user may decide that the box be moved to a new location based on its contents 170 and either leaves the box alone 174 or moves it to the new location 172. Lastly, the user decides if there are more items to be searched for or there are more boxes to check 175 and if so goes to the next box and scans it with the RFID reader 178 and the process repeats itself 164. If there are no more items to be searched the process finishes 180.

The invention may be embodied in other specific forms without departing from its spirit or essential characteristics. The described embodiments are to be considered in all respect only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A system for instant recognition of contents of a closed container using identification tags, comprising:
providing descriptive information of contents stored within a container taken during container packing wherein a computer system stores said descriptive information in a database and associates it with an identification tag having a unique identification number which is affixed to the container for later reference and retrieval of the contents.

2. The system for instant recognition of contents of a closed container using identification tags according to claim 1, wherein said descriptive information is a picture.

3. The system for instant recognition of contents of a closed container using identification tags according to claim 1, wherein said descriptive information is an audio description.

4. A system for instant recognition of contents of a closed container using identification tags according to claim 1, wherein said descriptive information is in text.

5. The system for instant recognition of contents of a closed container using identification tags according to claim 1, wherein said identification tag having a unique identification number is a radio frequency identification tag.

6. The system for instant recognition of contents of a closed container using identification tags according to claim 1, wherein said identification tag having a unique identification number is a barcode label.

7. A system for instant recognition of contents of a closed container using identification tags according to claim 1, wherein said computer system stores said descriptive information in a database and associates it with an identification tag using a radio frequency identification reader/interrogator.

8. A system for instant recognition of contents of a closed container using identification tags according to claim 1, wherein said computer system stores said descriptive information in a database and associates it with an identification tag using a bar code reader.

9. The system for instant recognition of contents of a closed container using identification tags according to claim 1, wherein said descriptive information is provided by a digital camera taking one or more pictures of the contents being packed and associated said one or more pictures with said identification tag.

10. The system for instant recognition of contents of a closed container using identification tags according to claim 1, wherein said descriptive information is provided by a microphone/audio analog-to-digital converter wherein a digital voice recording describing the contents is associated with said identification tag.

11. A system for instant recognition of contents of a closed container using identification tags according to claim 1, wherein said descriptive information is provided by a microphone/audio analog-to-digital converter fed to a speech recognition text converter wherein a digital voice recording is converted to text describing the contents is associated with said identification tag.

12. A system for instant recognition of contents of a closed container using identification tags according to claim 1, wherein said descriptive information is provided by a keyboard used to enter text information describing the contents is associated with said identification tag.

13. The system for instant recognition of contents of a closed container using identification tags according to claim 1, wherein said descriptive information is printed out and placed on the container associated with said descriptive information.

14. A method for instant recognition of contents of a closed container using identification tags, comprising:
providing descriptive information of contents stored within a container at the time of packing;
storing said descriptive information in a database;
providing an identification tag having a unique identification number;
storing said unique identification number associated with said descriptive information in said database; and
affixing said identification tag to the container.

15. The method for instant recognition of contents of a closed container using identification tags according to claim 14, further comprising:
querying said identification tag having said unique identification number affixed to a closed container;
retrieving said descriptive information associated with said unique identification number from said database;
determining if said descriptive information is the contents desired wherein if the descriptive information is different then the contents desired then query another identification tag affixed to another closed container.

16. The method for instant recognition of contents of a closed container using identification tags according to claim 15, further comprising:
displaying said descriptive information to a user for determining if the contents of the closed container are desired.

17. The method for instant recognition of contents of a closed container using identification tags according to claim 14, further comprising:
converting said unique identification number from a barcode label to a radio frequency identification tag.

18. The method for instant recognition of contents of a closed container using identification tags according to claim 14, wherein querying said identification tag further comprises:
scanning said unique identification number affixed to a closed container using a radio frequency identification reader/interrogator.

19. The method for instant recognition of contents of a closed container using identification tags according to claim 14, wherein querying said identification tag further comprises:
scanning said unique identification number affixed to a closed container using a barcode label reader.

20. A method for instant recognition of contents of a closed container using radio frequency identification tags; comprising:
providing audio, video or text information of one or more contents stored within a container at the time of packing;
storing said audio, video or text information in a database;
providing a radio frequency identification tag having a unique identification number;
storing said unique identification number associated with said audio, video or text information is said database;
affixing said radio frequency identification tag to the container;
retrieving said audio, video or text information associated with said unique identification number from said database by querying said identification tag having said unique identification number affixed to a closed container; and
determining from said audio, video or text information by displaying said audio, video or text information to a user if the contents are desired wherein if the audio, video or text information is different then the audio, video or text information for the contents desired by the user then query another radio frequency identification tag affixed to another closed container.
